(19) United States
(12) Patent Application Publication
(10) Pub. No.: US 2020/0051071 A1
(43) Pub. Date: Feb. 13, 2020

(54) Electronic transaction system and method using a blockchain to store transaction records

(71) Applicant: ELAND BLOCKCHAIN FINTECH INC., San Jose, CA (US)

(72) Inventors: Ching Song WU, Taipei City (TW); Chun-Wei YU, New Taipei City (TW)

(21) Appl. No.: 16/492,706

(22) PCT Filed: Jul. 25, 2018
(86) PCT No.: PCT/US2018/043584

§ 371 Date: Sep. 10, 2019

Related U.S. Application Data
(60) Provisional application No. 62/537,523, filed on Jul. 27, 2017.

(51) Int. Cl. G06Q 20/36; H04L 9/06; G06Q 20/06; G06Q 20/22

(52) U.S. Cl. CPC G06Q 20/3678; H04L 9/0637; G06Q 20/223; G06Q 20/3676; G06Q 20/0658

(57) ABSTRACT

The present invention is related to an electronic transaction system using a blockchain to store transaction records. The electronic transaction system includes a computing device having a verification module, a processing module and a broadcasting module, and the blockchain includes a plurality of user nodes connecting to the computing device. The verification module is configured to generate notification information according to a transaction event, and the notification information is transmitted to a first and second user nodes. The processing module is configured to generate a first and second transaction currency values, the sum of which is zero, after the verification module receives the verification information from the first and second user nodes. The broadcasting module is configured to record transaction information associated with the transferring of the first and second transaction currency values in a data block, and to broadcast the data block to each of user nodes.

### SUBJECT OF THE INVENTION

The present invention is related to an electronic transaction system and method, in particular, an electronic transaction system and method using a blockchain to store transaction records.

### BACKGROUND OF INVENTION

Since the appearance of Bitcoin, blockchains, that are developed as the accounting method for Bitcoin and use distributed ledger technology (DLT), are appearing in a variety of commercial applications today. Given the potential of this distributed ledger technology to simplify current business operations, and to offer the ability to create businesses and operations that are both flexible and secure, it should not be surprised to see DLT services and products becoming more mainstream in the near future.

The primary characteristics underlying the blockchain technology are:
1. The blockchain is capable of maintaining and managing the general ledger.
2. The blockchain has complete information about different user addresses and their balances right from the genesis block to the most recently completed block.
3. An indelible record is created. However, once the private key is lost, the right to access the digital record is compromised.
4. For any transaction request, a digital signature is needed.

Given the above characteristics, the blockchain provides an open, transparent and decentralized operating mode which is most appropriate to be applied in a wide variety of commercial applications. However, for commerce and financial transactions using blockchain technology nowdays, there are still rooms for improvement with respect to transaction security, and the protection mechanism for the assets or equity needs to be established.

Given the above, there is a need to provide a novel and inventive electronic transaction system and method using a blockchain to store the transaction records, whereby the assets or rights of the users in every transaction event could be more effectively protected, and the obligations associated with the transaction event recorded.

### SUMMARY OF INVENTION

I. Blockchain may be used in commercial services industry under the condition that it has the management mechanism that would fulfil the relationship conditions and the scenarios of use as stated below:
1. Consent of all parties to the provisions (Mutual Agreement)
   (1) All civil rights and obligations shall be based on parties agreement.
   (2) In practical, a business contract shall only be executed under the consent of both parties in transaction (for example, Party A/Party B, the creditor/debtor, etc.).
   (3) Just like the principle of Yin and Yang, where all things exist as inseparable and contradictory opposites.
   (4) However, in existing blockchain technology, once Party A initiates a transaction, the transaction is realized and recorded on the blockchain without the consent of Party B (acceptor).
   (5) Execution of contracts and commerce transactions should be based on mutual agreement.
2. Lending and credit relationship:
   (1) It is noted that the general accounting criterion associated with commerce transaction adopted globally for centuries, no matter as for central bank notes, government bonds or company accounting bookkeeping, is in line with the principle of double-entry bookkeeping (compound borrowing rule).
   (2) The rights and obligations are quantified by the principles of lending.
   (3) The principles of lending is the criteria for recording contracts and business transactions.
   (4) The existing blockchain records the transaction in running accounts pattern, and the transaction records are incompatible with existing commerce transaction records. As such, blockchain lacks the mechanism to adapt itself for commercial use consequently, besides the bitcoin peer-to-peer transfer, the bitcoin Internet trading platforms, and some exchange platforms between legal money and bitcoin, blockchain does not effect any revolutionary changes to the typical business behaviors to date. The primary reason resides in that blockchain lacks a self-contained mechanism associated with the principles of lending.
3. Loss of the private key:
   (1) In practical, there is always a report loss mechanism for the loss of identities or notes.
   (2) However, the right of the blockchain is totally dependent on the private key. If an owner loses his private key, his rights will be compromised. This is the reason why the bitcoin blockchain cannot be used in the practical business field. If the owner has the risk of losing his rights to claim all his assets in one overnight, this loophole is totally unacceptable as far as a business activity or trading platform is concerned. As such, unless the loophole of losing all assets due to the loss of the private key is filled up, no business activity will be opened to the blockchain.

II. Technical measures and operating method of the present invention:
1. The absence of the principles of lending in the protocol of the blockchain is the key issue

According to the present invention, the principles of lending are introduced into the lending blockchain. The present invention provides a new rule and novel technology to solve the existing problem where the blockchain can not be used in the commercial services industry.
2. No change whatsoever is made to the structure of existing blockchain

The present invention is applicable to any blockchain, for example the bitcoin blockchain, Ethereum blockchain, or even the blockchain customized by the central bank. As the present invention does not make any changes to the basic structure of exiting internet platform (Web 2.0 certification; which is applicable for paying and borrowing), and meets the principles of double-entry bookkeeping in accounting, it may be adapted to work with existing systems of the central banks, commercial banks, and business sectors.
3. Transactions and records:

Each transaction of the digital currency such as the bitcoin shall be recorded as a record. Nonetheless, for each transaction made, typically it should have two records, one is the debit account, and the other, the credit account.

According to the present invention, for each transaction made, a gateway of the bookkeeping center issues a debit account (debit coin) to Party A, and a credit account (credit coin) to Party B at the same time.

Both Party A and Party B have to sign a signature and return the same to the gateway of the bookkeeping center so as to verify this transaction (this is the so-called “spirit of mutual agreement”, which is absent in the bitcoin transaction nowadays where one cannot refuse to accept the bitcoin).

The gateway bookkeeping center then broadcasts two transactions (a credit account transaction between the gateway bookkeeping center and Party A; and a debit account transaction between the gateway bookkeeping center and Party B; and the sum of the two accounts is zero) to the blockchain, and the transactions are recorded in the blockchain as permanent records.

III. Basic principle:
1. The status quo is not changed.
2. The existing structure of the blockchain is not changed, and thus the advantages and potential values of the blockchain are preserved.
3. It is not necessary to further develop or modify the environment of existing internet, and the operation specialists do not have to change their habits of operation to cope with the new principle and logic of the blockchain.
4. The business principle is not changed.
   The legal spirit of the contract is not ignored and the accounting rules are not changed. Only a gateway has to be further provided to analyze the agreement between the Internet and the blockchain.
5. Gateway does not involve in business activities, cash flow and business between both parties. It is only responsible for interpreting the protocol and coordinating the regulations. Such blockchain for interpreting the protocol and coordinating the regulations is called as Digital Ledger Chain (DLC). DLC would provide solutions to overcome the defects of the blockchain.
6. DLC is the reason why the blockchain technology according to the present invention may accomplish the following objectives:
   A. On one hand, it may cooperate with most of the existing business models and internet platforms. The trust mechanism of the blockchain may be established in the traditional platforms without having to change the original business principles, the standards for connecting the platforms and the principle for recording the rights.
   B. On the other hand, it can be linked to the bitcoin, Ethereum, Hyperlink and even the blockchain to be chosen or defined by the official authorities of various countries in the future. Therefore, the DLC will not have any conflict with existing regulations, policies and standards in its future development, and is suitable for long-term application and promotion.

IV. The present invention includes the following features:
1. Mutual agreement mechanism:
   Both Party A and B have to make the signatures to complete the contract, and DLC issues the certificates to both parties.
2. Lending and credit relationship:
   All transactions should meet the lending and credit principles, and the certifications for the lending and credit, and the corresponding accounts shall be issued. As such, the transactions can be directly connected to the conventional accounting system.
3. The lost of the private key is not a concern:
   The rights of the owner may be preserved, and the original assets reclaimed without violating the PM (public algorithm and mechanism for the public and private keys).
4. Low threshold for its use:
   All exiting businesses have been internet-enabled. There are de facto or main stream rule Web 2.0 for the professions of advertising, retail, payment and content provision, so that various industries are internet-enabled. The logical and content of existing blockchain are not readily compatible with the inertance of Web 2.0.

V. Solving the problem the central bank is facing when introducing blockchain:

The deputy president of the People's Bank of China stated in an article that: “The legal digital currency is bound to be affected by existing payment system and information technology, but it should also be differentiated from existing payment system in order to focus on its own service areas and to play its role in replacing traditional currencies. In theory, the payment system mainly deals with the demand deposits in the broad currency, while the digital currency mainly belongs to the category of cash (M0).”. The People's Bank of China restricts the digital currency to the function of M0 (cash) because the problem associated with the lending and credit principle is not yet solved to date. Electronic currency is the disguised currency for E-business bank system (the currency function generated from bookkeeping and clearing mechanisms); and digital currency is the currency defined by the blockchain mechanism.

The lending block of the double-entry bookkeeping system according to the present invention may solve the problem of failing to promote the paperless currency by the central banks of various countries. According to a publication of the England central bank:
1. The cash issued by the central bank and the reserves of the business banks in the central bank amount to only 2.6% of the currency circulation.
2. More than 97% of the currencies are digital currency generated by the business bank system (generated based on accounting method).
   As such, if the digital currency and the electronic money cannot be integrated, blockchain technology is worthless in the financial system.
   In the event that the digital currency is centralized and issued by the central bank,
1. The digital currency in the business bank belongs to the asset of the business bank, and the debt of the central bank.
2. The digital currency in a client's account in the business bank is the client's asset, and the debt of the central bank.
3. As for the peer-to-peer transaction of digital currencies between the clients, the central bank would take full responsibility as the transactions are verified and managed by the digital currencies issuing system of the central bank.
4. The transaction of digital currency is made through the interbank payment system of the central bank and the core business system of the business bank, which is in line with existing process.

VI. The method and principle underlying the present invention:

According to the agreement and white paper associated with bitcoin, coin transaction are developed, and the mining task is attached to the bitcoin blockchain to perform mining simultaneously. That is to say, the miner maybe rewarded with the bitcoin and the transaction coins. However, after years of promotion, it is found that the fundamental problem of the blockchain resides in that there is no real business operation besides the bitcoin. After a further research regarding the central bank's balance sheet and the principle of generating the currency by the business bank, the inventor has now succeeded in maturing the theoretical basis, structure and concept of the present invention.

However, business activities, except for a minority of underground economic activities, are all based on the functional logic of the central bank system and business bank. The present invention overcomes the conflicts of basic logics between the central bank and blockchain, and can be applied on the real business platforms, financial systems, legal systems and the general commercial activities. As such, the blockchain technology could be well adapted to the activities of the real word to solve the trust issues, avoid the risks, smooth the transactions and reduce the processing costs.

The main object of the present invention is to provide an electronic transaction system and method using a blockchain to store transaction records, so that a transaction record that has been mutually agreed upon and authorized by the users involved in the transaction is generated. The record would register the transaction values to be transferred in or out by each user in the transaction. The present invention also provides a preset mechanism for a backup of the private key so as to protect the user's right.

In order to achieve the above objects, one aspect of the present invention provides an electronic transaction system using a blockchain to store the transaction records. The electronic transaction system includes a computing device, and the blockchain includes a plurality of user nodes connecting to the computing device by a peer-to-peer network, and the plurality of user nodes have at least a first and second user nodes that correspond to a first and second user devices, respectively. The computing device includes a verification module, a processing module and a broadcasting module. The verification module is configured to generate two notification information that correspond to each other according to a transaction event, and are transmitted to the first and second user devices, respectively, and the verification module receives verification information verified and returned by a first and second users through the first and second user devices, respectively, and each notification information includes a transaction value. The processing module is configured to generate a first and second transaction currency values according to the transaction value after the verification module receives the verification information, wherein the sum of the first and second transaction currency values is zero. The broadcasting module is configured to record a transaction information associated with the transferring of the first and second transaction currency values to the first and second users, respectively, in a data block, and to broadcast the data block to each of user nodes.

A further aspect of the present invention provides an electronic transaction method using a blockchain to store transaction records. The electronic transaction method includes the steps of: providing a computing device having a verification module, a processing module and a broadcasting module, wherein the blockchain includes a plurality of user nodes connecting to the computing device by a peer-to-peer network, and the plurality of user nodes having at least a first and second user nodes that correspond to a first and second user devices, respectively; generating two notification information that correspond to each other according to a transaction event by means of the verification module, the two notification information are transmitted to the first and second user devices, respectively, and each notification information includes a transaction value; receiving the verification information verified and returned by the first and second users through the first and second user devices by means of the verification module; generating a first and second transaction currency values according to the transaction value by means of the processing module after receiving the verification information, wherein the sum of the first and second transaction currency values is zero; and recording a transaction information associated with the transferring of the first and second transaction currency values to the first and second users, respectively, in a data block and broadcasting the data block to each of the user nodes by means of the broadcasting module.

Another aspect of the present invention provides an electronic transaction system using a blockchain to store the transaction records. The electronic transaction system includes a computing device, and the blockchain includes a plurality of user nodes connecting to the computing device by a peer-to-peer network, and the plurality of user nodes have at least a first and second user nodes. The computing device includes a verification module, a processing module and a broadcasting module. The verification module is configured to generate two notification information that correspond to each other according to a transaction event, and are transmitted to the first and second user nodes, respectively, and the verification module receives verification information verified and returned by a first and second users through the first and second user nodes, respectively, and each notification information includes a transaction value. The processing module is configured to generate a first and second transaction currency values according to the transaction value after the verification module receives the verification information, wherein the sum of the first and second transaction currency values is zero. The broadcasting module is configured to record a transaction information associated with the transferring of the first and second transaction currency values to the first and second users, respectively, in a data block, and to broadcast the data block to each of user nodes.

Accordingly, the user can use the above electronic transaction system and method using a blockchain to store transaction records, so as to generate a transaction record that has been mutually agreed upon by multiple users associated with the transaction, and to record the transferred transaction values are the liability obligation of each user. Further, in the event of loss of the private key, the user may preserve his rights by initiating a backup mechanism provided by the present invention.

### BRIEF DESCRIPTION OF DRAWINGS

FIG. 1 illustrates an electronic transaction system using a blockchain to store transaction records according to an embodiment of the present invention.

FIG. 2 illustrates an electronic transaction system using a blockchain to store transaction records according to another embodiment of the present invention.

FIG. 3 illustrates an electronic transaction system using a blockchain to store transaction records according to a further embodiment of the present invention.

FIG. 4 schematically illustrates a first transaction account and a second transaction account according to an embodiment of the present invention.

FIG. 5 schematically illustrates a first transaction account and a first backup transaction account according to an embodiment of the present invention.

FIG. 6 illustrates a processing flowchart of an electronic transaction method using a blockchain to store transaction records according to an embodiment of the present invention.

FIG. 7 illustrates a processing flowchart of the electronic transaction method using a blockchain to store transaction records according to an embodiment of the present invention.

FIG. 8 illustrates a processing flowchart of the electronic transaction method using a blockchain to store transaction records according to an embodiment of the present invention.

FIG. 9 illustrates a processing flowchart of the electronic transaction method using a blockchain to store transaction records according to an embodiment of the present invention.

### DETAILED DESCRIPTION

The present invention is related to an electronic transaction system and an electronic transaction method for a blockchain adapted to store transaction records. In the descriptions, similar elements will be denoted by the same reference numerals. Moreover, the drawings of the present invention are only schematic illustrations and are not necessarily drawn to scale, and may not show all details therein.

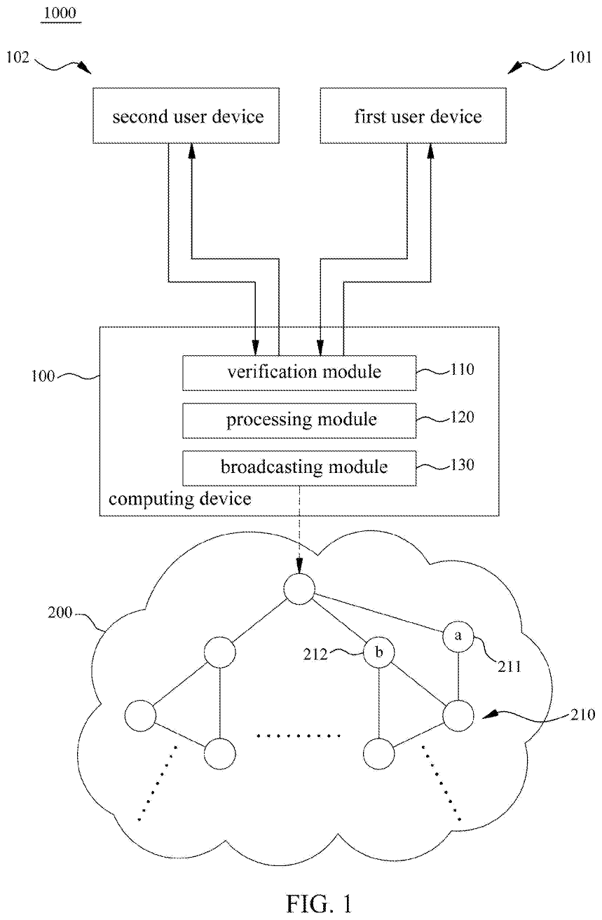

Referring to FIG. 1, FIG. 1 illustrates an electronic transaction system using a blockchain to store transaction records according to an embodiment of the present invention. As shown in FIG. 1, an electronic transaction system 1000 using a blockchain to store transaction records includes a computing device 100. The blockchain 200 includes a plurality of user nodes 210 connecting to the computing device 100 by a peer-to-peer network. The user nodes 210 include a first and second user nodes 211, 212 that correspond to a first and second user devices 101, 102, respectively. In this embodiment, the first user device 101 and the second user device 102 may be an electronic device, for example, a hand-held mobile electronic device, laptop computer or desktop computer.

The computing device 100 includes a verification module 110, a processing module 120 and a broadcasting module 130. The verification module 110 is configured to verify whether a transaction event between the users is authorized and agreed upon by all. More particularly, the verification module 110 may generate two pieces of notification information that correspond to each other according to a transaction event associated with the first and second users. The two pieces of notification information are transmitted to the first and second user nodes 211 and 212, respectively. Each piece of notification information includes a transaction value. For example, the notification information transmitted to the first user node 211 may contain the information about the transaction value that the first user has gained or has to pay in this transaction event, or even contain the information of other users involved in this transaction if necessary. Similarly, the notification information transmitted to the second user node 212 may contain the information about the transaction value that the second user has gained or has to pay in this transaction event. On the other hand, the verification module 110 will receive from the first and second user nodes 211, 212 the first and second verification information sent by the first and second users, respectively, confirming on the transaction values gained or to pay as stated in the notification information.

In a further embodiment of the present invention, the first user node includes a first private key and a paired first public key, and the second user node includes a second private key and a paired second public key. The first and second private keys are directed to private information for the first and second users respectively, and are used for verifying the user's identities to access the corresponding transaction accounts. The first and second public keys are directed to public information. However, the first verification information and the second verification information, that are respectively verified and returned from the first user and the second user through the first and second user devices, are respectively encrypted by the first user's first private key and the second user's second private key, in order to further verify that the first and second verification information have been authorized by the first and second users respectively, and that the transaction event involved is conducted based on mutual agreement between the first and second users.

Referring again to FIG. 1, after the verification module 110 receives the first and second verification information respectively from the first and second users, which implies that the transaction event has been mutually agreed upon and authorized by the first and second users, the processing module 120 generates a first and second transaction currency values that correspond to the transaction value of the transaction event, in which the sum of the first and second transaction currency values is zero.

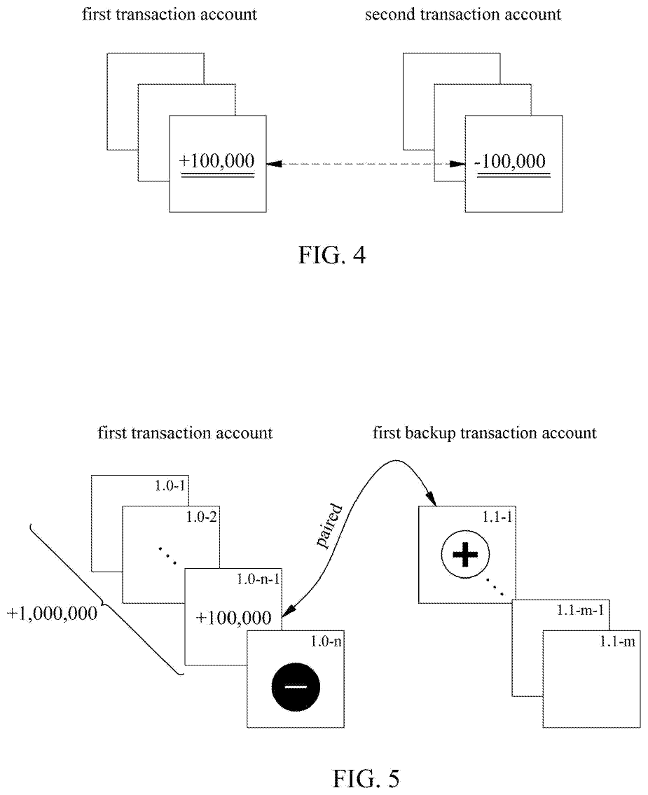

FIG. 4 schematically illustrates a first and second transaction accounts according to an embodiment of the present invention. In this embodiment, for example, when the first user acquires a first transaction currency value from a transaction event, and the second user should pay a second transaction currency value correspondingly for the event, the first transaction currency value is a positive value, for example +100,000, and recorded in a first transaction account, s whereas the second transaction currency value is a negative value, for example −100,000, and vice versa.

According to one embodiment of the present invention, when the sum of the balance value of the first transaction account and the first transaction currency value (acquired by the processing module 120 from the blockchain through the first public key) is negative, or when the sum of the balance value of a second transaction account and the second transaction currency value (acquired from the blockchain by the second public key) is negative, the broadcasting module will cease to record the transaction information regarding the transfer of the first and second transaction currency values to the first and second users respectively in a data block. In other words, when the balance in the first transaction account of the first user or the balance in the second transaction account of the second user is insufficient to pay in full the transaction currency value needed for transfer, the processing module 120 will automatically cease all subsequent transactions.

In this embodiment, when the processing module 120 confirms that the transaction event is mutually agreed upon by the first and second users, and the balance values of the first and second transaction accounts are sufficient to pay the transaction currency value to be transferred, the broadcasting module 130 will record the transaction information regarding the transfer of the first and second transaction currency values to the first and second users respectively in a data block. The broadcasting module will then broadcast the data block into each of user nodes of the blockchain.

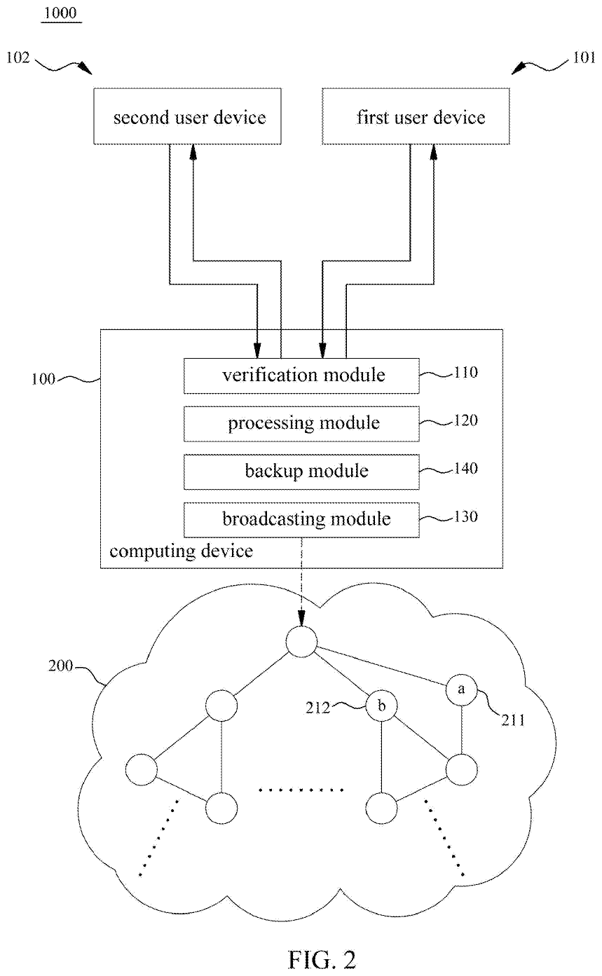

Referring to FIG. 2 which schematically illustrates an electronic transaction system using a blockchain to store transaction records according to an embodiment of the present invention. As shown in the figure, an electronic transaction system 1000 using a blockchain to store transaction records may further include a backup module 140. The backup module 140 is configured to receive a preset information encrypted and certified by a first biological feature information from the first user node. The broadcasting module 130 writes the preset information into a further data block which is then broadcasted to each of the user nodes. In this embodiment, the first biological feature information may be the information of the first user's biological features, such as the fingerprint, voiceprint, iris of the eye, ear's contour or components of the body fluids.

in particular, the preset information includes a private key replacing assignment command and a path linking command. The private key replacing assignment command is intended to provide, after the biological feature information of the first user has been certified, a first backup private key to replace the first private key, and a first backup transaction account to replace the first transaction account, thereby renders the first user may access his transaction information. The path linking command is configured to transfer a zeroing transaction currency value and a paired initializing transaction currency value to the first transaction account and the first backup transaction account, respectively, and the transaction information regarding this transfer is recorded into a further data block, which is then broadcasted to each of the user nodes of the blockchain.

Moreover, FIG. 5 schematically illustrates a first transaction account and a first backup transaction account according to an embodiment of the present invention. In this embodiment, the sum of the zeroing transaction currency value and the balance value of the first transaction account obtained from the blockchain by the first public key is zero, and the sum of the zeroing transaction currency value and the initializing transaction currency value is zero. The zeroing transaction currency value generated by the backup module 140 and transmitted to the first transaction account is illustrated as a black coin recording symbol in the transaction record (1.0-n) as shown in FIG. 5. The zeroing transaction currency value is a negative value corresponding to the balance value (+1,000,000) of the first transaction account obtained from the blockchain 200 by the first public key, for example, −1,000,000. The initializing transaction currency value of the first backup transaction account is the balance value of the first transaction account obtained from the blockchain 200 by the first public key, that is the white coin recording symbol in transaction record (1.1-1) as illustrated in FIG. 5.

As such, after the first transaction account receives the preset, zeroing transaction currency value, the balance value of the first transaction account will become zero directly. On the other hand, as the transaction value first received by the first backup transaction account is the initializing transaction currency value, the first backup transaction account can effectively inherit the cumulative transaction values of the first transaction account.

With the aid of the backup module 140 as mentioned above, when a user loses his/her private key, he/she can activate the private key replacing assignment command and path linking command through the preset biological feature information, so as to generate a backup transaction account to have access to the transaction account associated with the private key which has been lost. In this manner, the existing transaction records of the first backup transaction account can effectively trace back to the first transaction record of the first transaction account. The rights of the user is thereby protected. Although the above embodiments are illustrated and explained for the case of the first user, one should appreciate that the embodiment may also be adapted for the case of the second user.

In a further embodiment of the present invention, when the user loses his private key, the private key replacing assignment command and the path linking command can be activated through the aid of the preset biological feature information. The backup module 140 may then generate a transaction record associated black coin and a transaction record associated white coin that are transmitted to the first transaction account and the first backup transaction account, respectively, in order to freeze the transactions of the first transaction account, and to enable the first backup account, in the course of calculating the balance value, to trace back to the first transaction record of the first transaction account without involving any transfer of the assets in between the accounts. As such, the user may inherit the rights to the assets and the liability obligation of the first transaction account through the first backup transaction account.

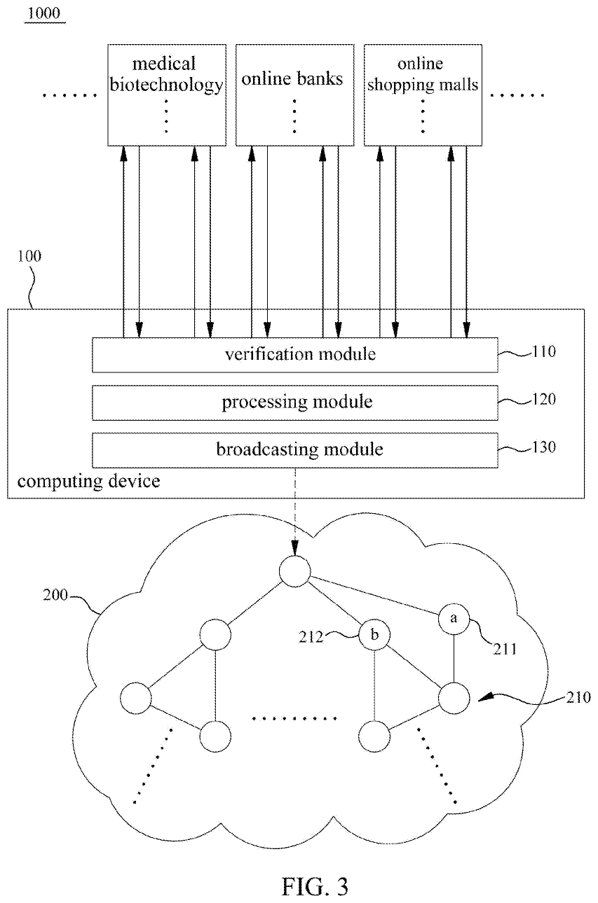

Referring to FIG. 3, all the electronic transaction system 1000 using a blockchain to store transaction records as mentioned above, can effectively generate transaction records among multiple parties based on mutual agreement basis, so as to record the assets and liability obligation of each and every user in the transaction event mutually agreed upon, the transaction account and the backup mechanism for the user's private key to thereby protect the rights of the users. As such, the electronic transaction system according to the present invention may be introduced into the technical fields of the online shopping malls, the online banks, the medical biotechnology, the asset trading, and the social communications.

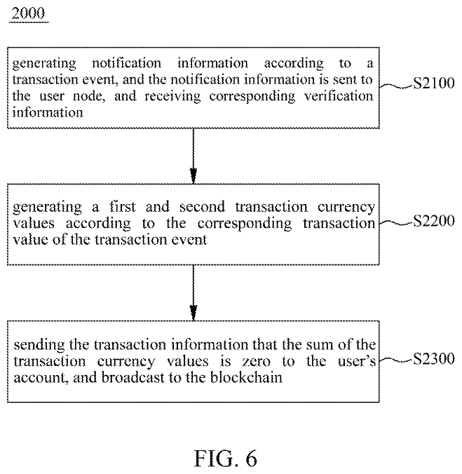

Referring to FIG. 6 which illustrates a processing flowchart of an electronic transaction method using a blockchain to store transaction records according to an embodiment of the present invention. The electronic transaction method 2000 is applicable to the electronic transaction system 1000 as mentioned hereinbefore. As shown in FIG. 6, the electronic transaction method 2000 includes a transaction verifying step S2100. In the transaction verifying step S2100, notification information according to a transaction event is generated and sent to the user node, and corresponding verification information is received. More specifically, when the transaction verifying step S2100 is applied onto the electronic transaction system 1000, two pieces of notification information that correspond to each other according to the transaction event are generated and are respectively sent to the first and second user nodes. Moreover, the verification information verified and returned by the first and second users are received through the first and second user nodes. Each of the notification information includes a transaction value.

Secondly, the electronic transaction method 2000 comprises a transaction currency generating step S2200. The transaction currency generating step S2200 generates a first and second transaction currency values according to the corresponding transaction value of the transaction event. More specifically, when the transaction verifying step S2200 is applied onto the above electronic transaction system 1000, after the verification module 110 receives the first and second verification information from the first and second users respectively, the first and second transaction currency values are generated according to the transaction value. The sum of the first and second transaction currency values is zero. For instance, the first transaction currency value is a positive transaction currency value, and the second transaction currency value is a negative transaction currency value. Moreover, in this step, the first and second verification information that are returned from the first and second users, are respectively encrypted and certified by the first and second private keys.

Moreover, the electronic transaction method 2000 comprises a transaction information broadcasting step S2300, in which the transaction information that the sum of the transaction currency values is zero are sent to the user's account and broadcasted to the blockchain. More particularly, when the transaction information broadcasting step S2300 is applied onto the above electronic transaction system 1000, the transaction information about the transfer of the first and second transaction currency values to the first and second users is recorded in a data block, and then the data block is broadcasted to each of the user nodes.

Further, in the transaction information broadcasting step S2300, when the sum of the balance value of a first transaction account and a first transaction currency value (acquired from the blockchain by the first public key) is negative, or when the sum of the balance value of a second transaction account and a second transaction currency value (acquired from the blockchain by the second public key) is negative, the broadcasting module 130 will cease to record the transaction information regarding the transfer of the first and second transaction currency values to the first and second users, respectively, in a data block. As such, when the balance value in the first transaction account of the first user or the balance value in the second transaction account of the second user is insufficient to pay in full the transaction currency value needed for transfer, the subsequent transactions will be stopped.

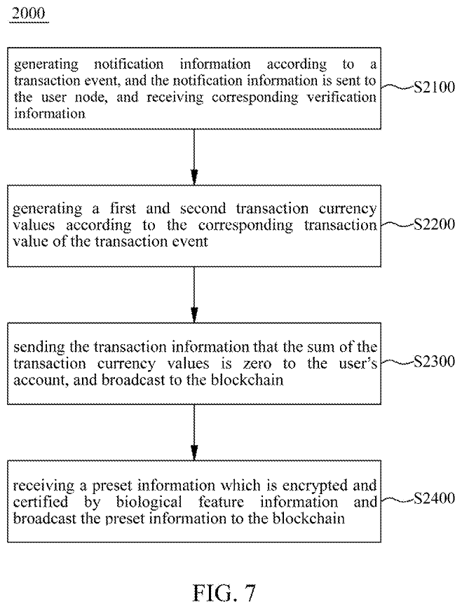

Please refer to FIG. 7 which illustrates a processing flowchart of the electronic transaction method using a blockchain to store transaction records according to an embodiment of the present invention. As shown in FIG. 7, the electronic transaction method 2000 comprises a backup account presetting step S2400. The backup account presetting step S2400 is to receive a preset information which is encrypted and certified by biological feature information and broadcast the preset information to the blockchain. That is to say, when the backup account presetting step S2400 is applied onto the above electronic transaction system 1000 using a blockchain to store transaction records, the backup module 140 will receive the preset information encrypted and certified by a first biological feature information from the first user node, and the broadcasting module 130 will write a preset information in a further data block and broadcast the further data block to each of the user nodes.

In this embodiment, the preset information may further comprise a private key replacing assignment command and a path linking command. However, as the function and the effect of the private key replacing assignment command and the path linking command of the electronic transaction method 200 are similar to those of the private key replacing assignment command and the path linking command of the electronic transaction system 1000 in the above embodiments, the descriptions regarding the private key replacing assignment command and path linking command are omitted.

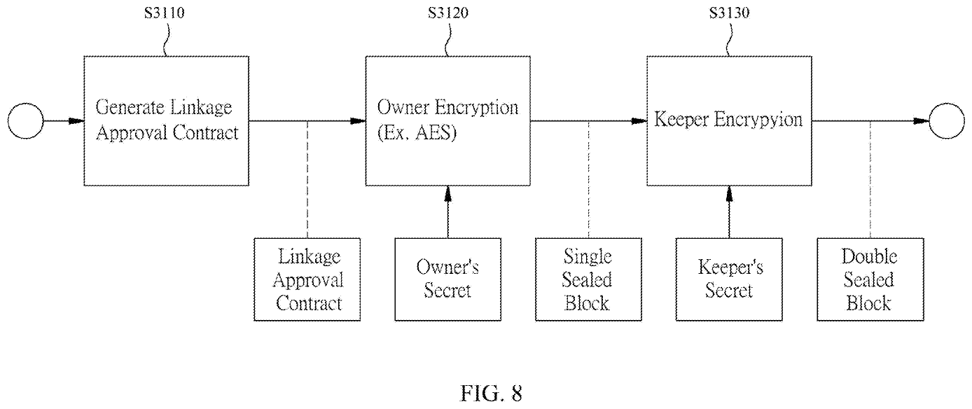

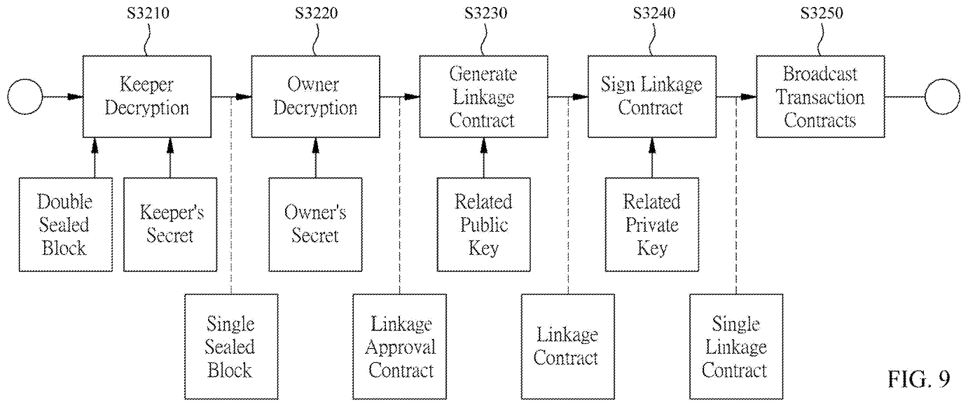

FIG. 8 and FIG. 9 illustrate a processing flowchart of the electronic transaction method using the blockchain for storing the transaction record according to an embodiment of the present invention. A pre-encryption backup mechanism is provided to prevent the user from losing the rights to access the account when his personal private key is lost. As shown in FIG. 8, according to the electronic transaction method 3000, in step S3110, a linkage approval contract information is generated in the computing device (such as a gateway), and the linkage approval contract information is transmitted to a user terminal. Then, in step S3120, the linkage approval contract information is encrypted by the user's private password so as to form a single sealed block, which is returned to the computing device. The private password can be user's biological feature information, such as fingerprint, voiceprint, iris of the eye, ear's contour or components of body fluids. Moreover, in step S3130, the single sealed block will be encrypted by an administrator password, for example by performing AES algorithm encryption, so as to form a double sealed block, which is then kept and managed by the computing device. That is to say, the link approval contract information, which is double encrypted by the user's private password and the manager's administrator password, is kept and managed by a system manager in the computing device or other database applicable, so as to establish a link approval mechanism which is pre-encrypted by a user.

However, when the user loses his/her original private key, he/she can protect and preserve his/her rights by means of the linking approval mechanism which the user has previously encrypted. In particular, as shown in FIG. 9, in step S3210, the system manager may use the administrator password to recover the double sealed block that is kept and managed in the computing device into a single sealed block which is then transmitted to the user terminal. Then, in step S3220, the user uses the private password to recover the single sealed block in order to obtain the link approval contract information. Moreover, in step S3230, by means of the user's public key paired with his/her original private key (that has been lost), linkage approval contract information that the user has pre-encrypted may generate a corresponding connecting contract, wherein the connecting contract has been pre-encrypted by the original private key in the user's existing account. Secondly, in step S3240, by means of a backup private key associated with the user's further backup account, the connecting contract is encrypted so that the user's existing account and backup account may acquire the transaction record connecting black coin and transaction record connecting white coin, respectively. Further, in step S3250, the transaction information regarding the acquirements of the transaction record linking black coin and white coin by the user's original account and backup account, respectively, is broadcasted to the blockchain.

Given the above, through the transmission and linkage of the transaction records associated with the black and white coins, the user's existing account can be frozen, and the calculation of the balance value of the user's backup account can trace back to the first transaction record in the user's existing account. In other words, the user may use the backup transaction account to inherit the assets of existing transaction account based on the transaction record associated with black and white coins without having to transfer any existing asset.

The above embodiment is only for convenience of illustration and is merely exemplary. The scope of rights claimed by the present invention shall be subject to the scope of the application for patent, and not limited to the above embodiment.

1. An electronic transaction system using a blockchain to store transaction records, the electronic transaction system comprising a computing device, and the blockchain comprising a plurality of user nodes connecting to the computing device by a peer-to-peer network, the plurality of user nodes having at least a first and second user nodes that correspond to a first and second user devices, respectively, wherein the computing device comprises:
a verification module configured to generate two notification information that correspond to each other according to a transaction event, and are transmitted to the first and second user devices, respectively, and the verification module receives verification information verified and returned by a first and second users through the first and second user devices, respectively, and each notification information includes a transaction value;
a processing module configured to generate a first and second transaction currency values according to the transaction value after the verification module receives the verification information, wherein the sum of the first and second transaction currency values is zero; and
a broadcasting module configured to record a transaction information associated with the transferring of the first and second transaction currency values to the first and second users, respectively, in a data block, and to broadcast the data block to each of user nodes.

2. The electronic transaction system according to claim 1, wherein the first transaction currency value is a positive transaction currency value, and the second transaction currency value is a negative transaction currency value.

3. The electronic transaction system according to claim 1, wherein the first user node includes a first private key and a first public key, and the second user node includes a second private key and a second public key, and the verification information returned by the first user is encrypted and certified by the first private key and the verification information returned by the second user is encrypted and certified by the second private key, the broadcasting module stops recording the transaction information associated with the transferring of the first and second transaction currency values to the first and second users, respectively in a data block, when a sum of the first transaction currency value and a balance value of a first transaction account obtained from the blockchain by the first public key is negative, or when a sum of the second transaction currency value and a balance value of a second transaction account obtained from the blockchain by the second public key is negative.

4. The electronic transaction system according to claim 1, further comprising a backup module configured to receive a preset information that is encrypted and certified by a first biological feature information from the first user node, and the broadcasting module writes the preset information into a further data block, and broadcasts the further data block to each of the user nodes.

5. The electronic transaction system according to claim 4, wherein the preset information comprises a private key replacing assignment command configured to provide a first backup private key and a first backup transaction account after being certified by the first biological feature information, and a path linking command configured to transfer a zeroing transaction currency value and a corresponding initializing transaction currency value to the first transaction account and the first backup transaction account, respectively, and the sum of the zeroing transaction currency value and a balance value of the first transaction account obtained from the blockchain by the first public key is zero, and the sum of the zeroing transaction currency value and the initializing transaction currency value is zero.

6. An electronic transaction method using a blockchain to store transaction records, comprising the steps of:
providing a computing device having a verification module, a processing module and a broadcasting module, wherein the blockchain comprises a plurality of user nodes connecting to the computing device by a peer-to-peer network, and the plurality of user nodes having at least a first and second user nodes that correspond to a first and second user devices, respectively;
generating two notification information that correspond to each other according to a transaction event by means of the verification module, the two notification information are transmitted to the first and second user devices, respectively, and each notification information includes a transaction value;
receiving the verification information verified and returned by the first and second users through the first and second user devices by means of the verification module;
generating a first and second transaction currency values according to the transaction value by means of the processing module after receiving the verification information, wherein the sum of the first and second transaction currency values is zero; and
recording a transaction information associated with the transferring of the first and second transaction currency values to the first and second users, respectively, in a data block and broadcasting the data block to each of the user nodes by means of the broadcasting module.

7. The electronic transaction method according to claim 6, wherein the first transaction currency value is a positive transaction currency value, and the second transaction currency value is a negative transaction currency value.

8. The electronic transaction method according to claim 6, wherein the first user node includes a first private key and a first public key, and the second user node includes a second private key and a second public key, and the electronic transaction method further comprising:
using the first private key to encrypt and certify the verification information returned by the first user;
using the second private key to encrypt and certify the verification information returned by the second user; and
stop recording the transaction information associated with the transferring of the first and second transaction currency values to the first and second users, respectively, in a data block by the broadcasting module, when a sum of the first transaction currency value and a balance value of a first transaction account obtained from the blockchain by the first public key, is negative, or when a sum of the second transaction currency value and a balance value of a second transaction account obtained from the blockchain by the second public key is negative.

9. The electronic transaction method according to claim 8, further comprising:
receiving a preset information that is encrypted and certified by a first biological feature information from the first user node; and
writing the preset information in a further data block, and broadcasting the further data block to each of the user nodes by the broadcasting module.

9. The electronic transaction method according to claim 9, wherein the preset information comprises a private key replacing assignment command configured to provide a first backup private key and a first backup transaction account after being certified by the first biological feature information, and a path linking command configured to transfer a zeroing transaction currency value and a corresponding initializing transaction currency value to the first transaction account and the first backup transaction account, respectively, and the sum of the zeroing transaction currency value and a balance value of the first transaction account obtained from the blockchain by the first public key is zero, and the sum of the zeroing transaction currency value and the initializing transaction currency value is zero.
